(19) United States
(12) Patent Application Publication
(10) Pub. No.: US 2026/0113106 A1
(43) Pub. Date: Apr. 23, 2026

(54) HYBRID TERRESTRIAL-SATELLITE NETWORK MANAGEMENT FOR INTERNET OF THINGS DEVICES

(71) Applicant: T-Mobile USA, Inc., Bellevue, WA (US)

(72) Inventors: Anbalagan Elumalai, Issaquah, WA (US); Anupama Malireddy, Sammamish, WA (US); Karthik Chandrasekaran, Bellevue, WA (US)

(21) Appl. No.: 18/923,506

(22) Filed: Oct. 22, 2024

(51) Int. Cl. H04B 7/185; H04W 36/14

(52) U.S. Cl. CPC H04B 7/18591; H04W 36/14

(57) ABSTRACT

A server device for managing a hybrid satellite and terrestrial telecommunications network system for Internet of Things (IoT) devices receives monitoring data from IoT devices. Each of the IoT devices includes a dual network interface controller (NIC) configured to facilitate the connection of the respective IoT device to a terrestrial network and a satellite network and sensors for capturing the monitoring data. The monitoring data includes network infrastructure integrity data and environmental data that describes environmental conditions surrounding a respective IoT device. The server device determines that the terrestrial network is experiencing an interruption using the monitoring data and identifies a group of IoT devices to be switched from the terrestrial network to the satellite network using the monitoring data. The server device can cause the group of IoT devices to switch communication from the terrestrial network to the satellite network.

### BACKGROUND

The Internet of Things (IoT) includes interconnected devices embedded with sensors, software, and other technologies that enable them to collect and exchange data over the internet. IoT devices including drones and ground sensors can be used to monitor conditions during disasters and emergencies such as hurricanes, earthquakes, fires, and floods. These IoT devices can provide real-time data to emergency response teams, enabling timely and informed decision-making to enhance the safety and efficiency of recovery efforts. For example, a fleet of IoT-enabled drones and ground sensors deployed across a hurricane-prone region can monitor weather conditions, flood levels, and structural damage. Uninterrupted connectivity to transmit the monitoring data back to emergency response teams is crucial to enhancing the efficiency and effectiveness of disaster management operations.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates a system managing a hybrid terrestrial and satellite network for IoT devices.

FIG. 4 is a flow diagram that illustrates a process for managing a hybrid terrestrial and satellite network for IoT devices.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to systems and methods for the management of a hybrid terrestrial-satellite network for IoT devices. In particular, the disclosed technology can be applied to IoT devices collecting monitoring data during emergencies and disasters. The IoT devices can play a crucial role in such situations for monitoring conditions, coordinating response efforts, and ensuring the safety of people and infrastructure. However, the IoT devices themselves can experience challenges in maintaining communication when wireless network infrastructures are compromised. Conventional IoT network management technologies do not offer dynamic and seamless network switching between terrestrial and satellite networks for IoT devices.

The hybrid terrestrial-satellite network of the present disclosure can ensure that such IoT devices maintain connectivity even when terrestrial networks are damaged or overloaded. This concept involves an integrated network management system that dynamically switches IoT device connections between satellite and terrestrial networks using various criteria such as signal strength, cost, bandwidth availability, and network congestion. The disclosed management system can provide seamless connectivity by utilizing the strengths of both network types through dynamic configuration on IoT devices. The management system further takes into consideration cost-effectiveness (e.g., by prioritizing a less expensive network) and load balancing (e.g., by distributing data load between different networks to prevent congestion and enhance performance).

In one example, a server device for managing a hybrid satellite and terrestrial telecommunications network system for IoT devices receives monitoring data from IoT devices in an IoT network while the IoT devices are communicating with the server device via a terrestrial network. Each of the IoT devices can include a dual network interface controller (NIC) configured to facilitate the connection of the respective IoT device to the terrestrial network and a satellite network. The IoT devices can include sensors for capturing the monitoring data. The monitoring data can include network infrastructure integrity data and environmental data, and the environmental data can describe environmental conditions surrounding a respective IoT device of the IoT devices. The server device can determine that the terrestrial network is experiencing an interruption using the network infrastructure integrity data. The system can determine a metric indication of an interruption using the infrastructure integrity data in the monitoring data. The server device can identify a group of IoT devices to be switched from the terrestrial network to the satellite network using the metric indication of the terrestrial network experiencing an interruption and the received environmental data. The group of IoT devices can include at least a portion of the IoT devices in communication with the server device. The server device can cause the group of IoT devices to switch communication from the terrestrial network to the satellite network.

In another example, a server device for managing a hybrid network for IoT devices receives monitoring data from IoT devices in an IoT network while the IoT devices are communicating with the server device via a first network. Each of the IoT devices can include equipment to facilitate the connection of the respective IoT device to the first network and a second network. The monitoring data can include network infrastructure integrity data and environmental data. The server device can determine using the monitoring data that the first network is experiencing an interruption. The server device can identify a group of IoT devices to be switched from the first network to the second network using the monitoring data. The server device can cause the group of IoT devices to switch communication from the first network to the second network.

In yet another example, a method for managing a hybrid network system for IoT devices includes receiving monitoring data from IoT devices in an IoT network by a server device. The monitoring data is received while the IoT devices are communicating with the server device via a first network. Each of the IoT devices can include equipment to facilitate the connection of the respective IoT device to the first network and a second network. The monitoring data can include network infrastructure integrity data and environmental data. The method can include determining by the server device that the first network is experiencing an interruption using the network infrastructure integrity data. The method can include defining by the server device a group of IoT devices to be switched from the first network to the second network using the monitoring data. The method can include causing the group of IoT devices to switch communication from the first network to the second network.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

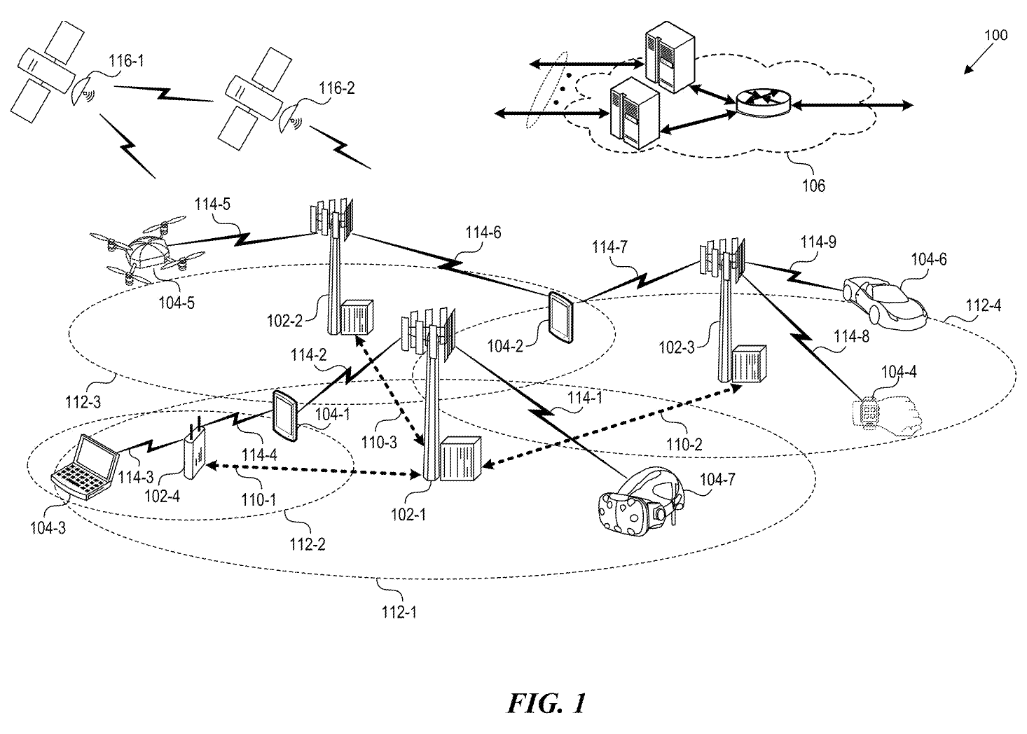

FIG. 1 is a block diagram that illustrates a wireless telecommunications network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104-1 through 104-7 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an /LTE-A or other network. In an LTE/LTE-A network, the term eNB is used to describe the base stations 102, and in 5G new radio (NR) networks, the term gNBs is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the system 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provides data to a remote server over a network; IoT devices such as wirelessly connected smart home appliances, etc.

A wireless device (e.g., wireless devices 104-1, 104-2, 104-3, 104-4, 104-5, 104-6, and 104-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102, and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or Time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites such as satellites 116-1 and 116-2 to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service requirements and multi-terabits per second data transmission in the 6G and beyond era, such as terabit-per-second backhaul systems, ultrahigh- definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low User Plane latency. In yet another example of 6G, the network 100 can implement a converged Wi-Fi and Core architecture to increase and improve indoor coverage.

### 5G Core Network Functions

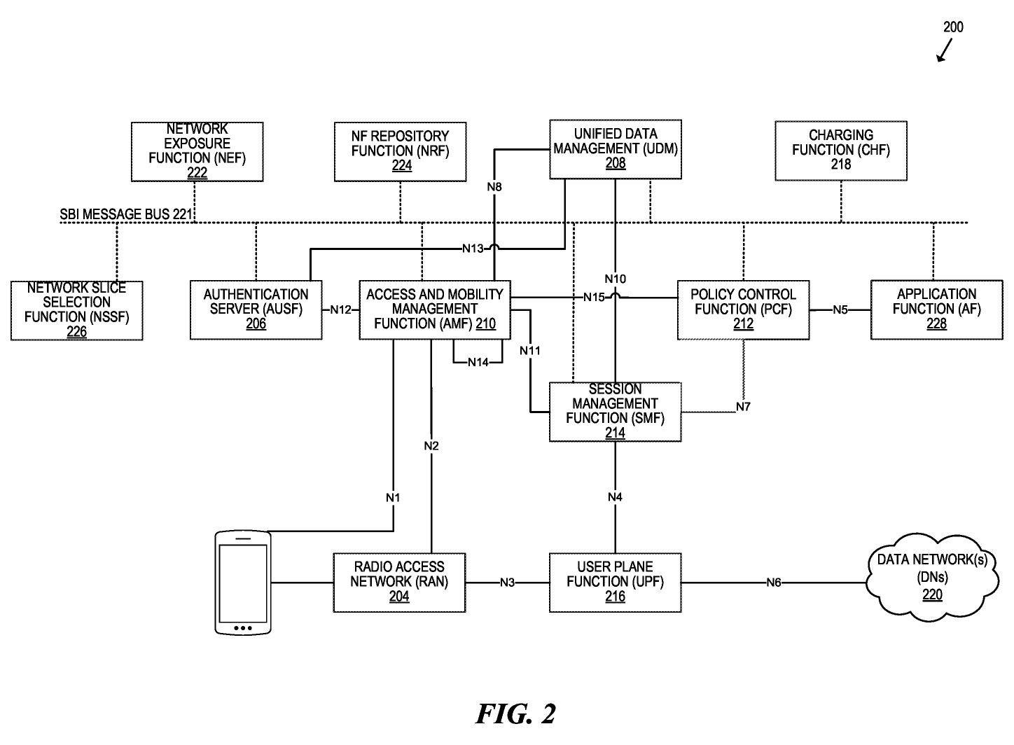

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, a NF Repository Function (NRF) 224 a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, service-level agreements, and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS), to provide authentication credentials while being employed by the AMF 210 and SMF 214 to retrieve subscriber data and context.

The PCF 212 can connect with one or more application functions (AFs) 228. The PCF 212 supports a unified policy framework within the 5G infrastructure for governing network behavior. The PCF 212 accesses the subscription information required to make policy decisions from the UDM 208, and then provides the appropriate policy rules to the control plane functions so that they can enforce them. The SCP (not shown) provides a highly distributed multi-access edge compute cloud environment and a single point of entry for a cluster of network functions, once they have been successfully discovered by the NRF 224. This allows the SCP to become the delegated discovery point in a datacenter, offloading the NRF 224 from distributed service meshes that make-up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224, use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework which, along with the more typical QoS and charging rules, includes Network Slice selection, which is regulated by the NSSF 226.

### Hybrid Terrestrial-Satellite Network for IoT Devices

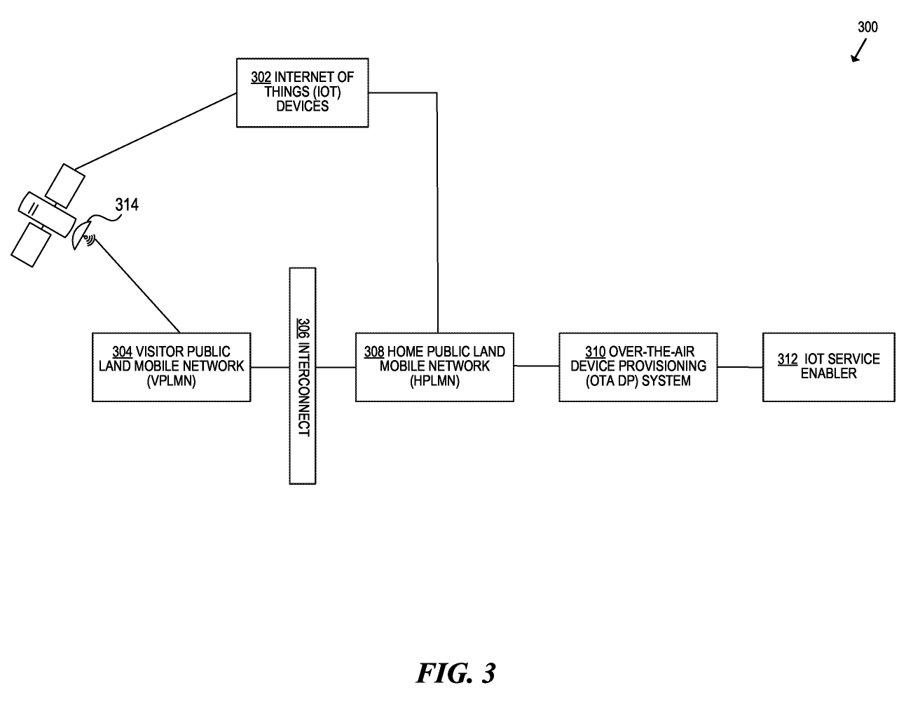

FIG. 3 is a block diagram that illustrates a hybrid terrestrial-satellite network system for IoT devices (e.g., a system 300). The system 300 includes an IoT service enabler 312, an over-the-air device provisioning (OTA DP) system 310, a home public land mobile network (HPLMN) 308, an interconnect 306, a visitor public land mobile network (VPLMN) 304, a satellite network 314, and IoT devices 302. In particular, the IoT devices 302 are configured for collecting and reporting real-time data to emergency response teams to enable timely and informed decision-making and enhance the safety and efficiency of recovery efforts. The IoT devices can be deployed across a geographical region that is currently experiencing an environmental disaster or has a high risk of environmental disasters. In particular, the system 300 facilitates reliable communication between the IoT devices 302 and the emergency agencies and officials via hybrid terrestrial-satellite network connectivity.

In FIG. 3, the HPLMN 308 is a primary mobile network that provides IoT devices 302 with access to communication within its coverage area. The HPLMN 308 can operate in various terrestrial mobile technologies as described with respect to FIGS. 1 and 2 (e.g., 5G and 6G networks). The VPLMN 304 refers to a mobile network that provides the IoT devices 302 access to communication outside the HPLMN 308 (e.g., roaming). The HPLMN 308 and the VPLMN 304 can communicate via the interconnect 306. For example, the interconnect 306 can enable signaling, billing, authentication, and data transfer between the two networks. In system 300, the VPLMN 304 is associated with the satellite network 314 which provides a mobile network to IoT devices 302 via satellites. A satellite network can refer to a network of low Earth orbit (LEO) satellites configured to provide high-speed internet access across the globe. A satellite network can, for example, provide mobile connectivity in instances where terrestrial networks are not available. For example, a satellite network can provide mobile connectivity when a terrestrial network is experiencing an interruption or in remote and underserviced areas that do not have sufficient terrestrial connectivity.

The IoT devices 302 of system 300 are configured to connect to terrestrial as well as satellite networks and include hardware that enables such connectivity. The IoT devices 302 can include, for example, satellite and terrestrial antennas and multi-mode modems configured to operate both satellite and terrestrial network signals. The equipment can further include signal amplifiers, routers, and authentication components (e.g., subscriber identity module (SIM) cards) that facilitate connectivity to both terrestrial and satellite networks. Further, the IoT devices 302 include software and firmware that can manage the connection protocols for both terrestrial and satellite networks. The hardware, firmware, and software configuration of the IoT devices 302 can provide for seamless switching mechanism between the terrestrial and satellite networks. In some implementations, the hardware, firmware, and software configuration of the IoT devices 302 can allow the devices to connect to both terrestrial and satellite networks simultaneously. In such implementations, each of the IoT devices 302 includes a dual NIC that provides the ability to connect to the two separate networks simultaneously. The dual NIC can enable, for example, redundancy, load balancing, and separation of network trafficking when connected to the terrestrial and satellite networks simultaneously. The seamless switching mechanism and IP session continuity can be employed by a handover protocol that manages the transition between networks smoothly to avoid data loss and interruptions. The IP session continuity is important for ensuring that applications operating on the IoT devices do not lose connectivity during the switch. In some implementations, the firmware is configured to operate according to security measures to ensure secure data transmission during network switching. Such security measures can include encryption standards, network monitoring capabilities and intrusion detection capabilities.

As described, the IoT devices 302 of the system 300 can be configured to monitor and report conditions during natural and/or manmade disasters and emergencies (e.g., storms, floods, fires, earthquakes, tsunamis, nuclear disasters, explosions, chemical exposures, etc.). The IoT devices 302 can include drones (e.g., aerial vehicles) and/or terrestrial devices (e.g., terrestrial vehicles or standstill devices) designed to collect monitoring data and report critical environmental and infrastructure conditions in real-time, providing valuable data for emergency response and disaster management. The IoT devices 302 can include sensors configured to collect environmental information associated with the surroundings of the respective device. As an example, the environmental data includes information related to weather conditions (e.g., rainfall, snowfall, wind speed, temperature, humidity), seismic information, flood level information, chemical concentration information, fire and smoke information, radiation information, and other relevant information. The IoT devices 302 are configured to communicate the environmental data in real-time to emergency authorities in order to assist in disaster recovery and/or prevention.

The IoT devices 302 of system 300 are further configured to collect monitoring data (e.g., real-time data). The monitoring data can include data associated with network infrastructure integrity (for terrestrial and satellite networks). The monitoring data can be collected through various sensors. For example, network infrastructure integrity data can include information and metrics used to measure the reliability, security, and optimal performance of a network. The information can include signal strength, bandwidth availability, latency, network congestion, Quality of Service (QoS) parameters (e.g., round trip time (RTT), or other parameters. For example, an IoT device can include a signal strength sensor that is configured to detect signal strength for terrestrial and satellite network connections. The signal strength can be detected in real time in order to assess the network access quality continuously. As another example, an RTT can be measured to assess latency and response times to evaluate network performance.

The network connectivity of the IoT devices 302 is managed by the IoT service enabler 312. The IoT service enabler 312 can include software (e.g., algorithms) that can evaluate the need for switching between the different networks using the monitoring data received from the IoT devices 302 and cause the IoT devices 302 to switch between the different networks accordingly. The IoT service enabler 312 can be associated with the HPLMN 308. The IoT service enabler 312 is in communication with the HPLMN 308 via the OTA DP system 310. The OTA DP system 310 enables remote configuring and managing of the IoT devices 302 through wireless communication. This process allows the IoT devices 302 to be set up, updated, and maintained without the need for physical access, making it highly efficient for large-scale deployments. The OTA DP system 310 can manage the IoT devices 302 via a lightweight machine-to-machine (LwM2M) communication protocol. The LwM2M protocol refers to an IoT device management protocol that can allow IoT devices to be updated while maintaining their operation.

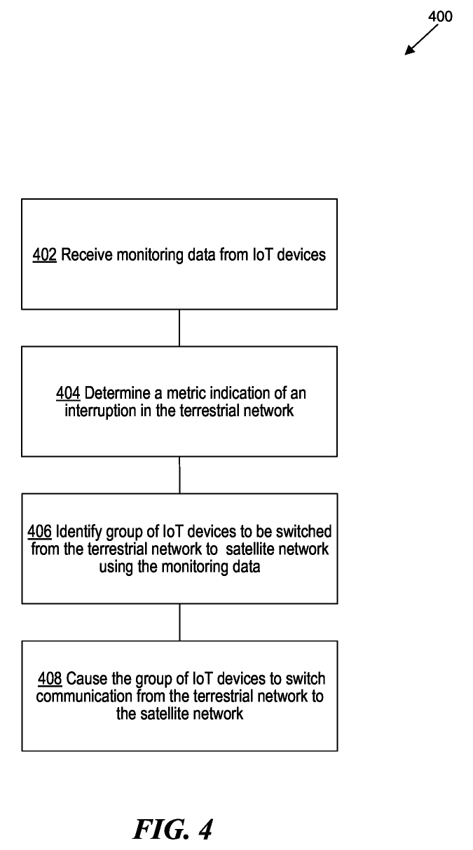

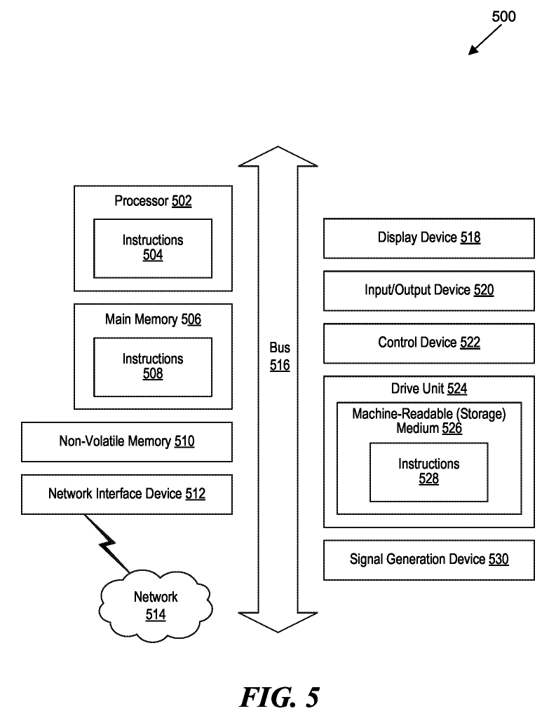

FIG. 4 is a flow diagram that illustrates a process 400 for managing a hybrid terrestrial-satellite network for IoT devices. The process 400 can be performed by a server device (e.g., the IoT service enabler 312 of system 300 in FIG. 3) associated with a wireless network (e.g., the wireless network 100 in FIG. 1). The server device can be associated with a telecommunications network and include at least one hardware processor and at least one non-transitory memory storing instructions (e.g., a computer system 500 described with respect to FIG. 5). When the instructions are executed by the at least one hardware processor, the server device performs the process 400.

The process 400 is directed to the management of the hybrid terrestrial-satellite network connectivity of IoT devices (e.g., the IoT devices 302 of system 300 in FIG. 3) that are configured for collecting and reporting real-time data to emergency response agencies and officials. The process 400 enables real-time, reliable communication by causing the IoT devices to switch between terrestrial and satellite networks when, for example, a terrestrial network is experiencing congestion or an interruption.

At 402, the server device (e.g., the IoT service enabler 312) can receive monitoring data from IoT devices (e.g., the IoT devices 302) in an IoT network while the IoT devices are communicating with the server device via a terrestrial network (e.g., the HPLMN 308 is a terrestrial network such as a 5G or 6G network). In some implementations, the server device is configured to manage the connectivity of the IoT device using the LwM2M protocol by an OTA DP system (e.g., the OTA DP system 310). As shown in FIG. 3, the IoT service enabler 312 is in communication with the OTA DP system 310, which is further in communication with the IoT devices 302 via the HPLMN 308. The IoT service enabler 312 can provide instructions for the management of the IoT devices 302, in particular their connectivity to the terrestrial and satellite networks, to the OTA DP system 310, which then further communicates the instructions to the IoT devices 302 according to LwM2M protocol.

In some implementations, the IoT devices include drones and/or ground sensors (e.g., ground vehicles or standstill sensors) deployed across a geographical region having a high risk of environmental disasters or emergencies or that is currently experiencing an environmental disaster or emergency. Each of the IoT devices can include hardware, firmware, and software that enable the respective IoT device to connect to the terrestrial and satellite networks, as described with respect to FIG. 3. In some implementations, each of the IoT devices can include a dual NIC configured to facilitate the connection of the respective IoT device to the terrestrial network and a satellite network. The NIC can be configured to maintain connections to the terrestrial network and the satellite network simultaneously. This enables seamless switching between the different networks.

In some implementations, an internet protocol (IP) address associated with a particular IoT device of the IoT devices remains unchanged when the IoT device is caused to switch communication from the terrestrial network to the satellite network. This can be enabled, for example, by the seamless switching between the different networks that is facilitated by the dual NIC. Retaining the same IP address can be crucial for maintaining the operation of applications running on the IoT devices that switch between the different networks. Retaining the same IP address, together with other appropriate protocols, can enable continuous authentication across network switches to prevent security breaches and data encryption to for secure data transmission.

The IoT devices can include sensors for capturing the monitoring data. The monitoring data can include network infrastructure integrity data and environmental data. The environmental data can describe environmental conditions surrounding a respective IoT device of the IoT devices. In some implementations, the sensors of the IoT devices include one or more sensors for detecting environmental conditions associated with an environmental disaster (e.g., conditions associated with emergencies). The environmental data can include information related to weather conditions (e.g., rainfall, snowfall, wind speed, temperature, humidity), seismic information, flood level information, chemical concentration information, fire and smoke information, radiation information, and other relevant information. For example, the environmental sensors can include visual detectors (cameras), location detectors (e.g., global positioning system (GPS) detectors), and/or sensors for detecting rain, wind, temperature, seismic vibrations and movement, chemicals, smoke, flood level, radiation, and other environmental parameters. The network infrastructure integrity data can include signal strength, bandwidth availability, network congestion, or other parameters. For example, the sensors of the IoT devices include a network signal strength sensor, and the network infrastructure integrity data includes network signal strength data. The metric indication of the terrestrial network experiencing an interruption can be determined using one or more of the signal strength, bandwidth availability, network congestion, and other parameters. The metric indication can be used for evaluating the quality and reliability of the network connection.

The server device can determine that the terrestrial network is experiencing an interruption using the monitoring data (i.e., the network infrastructure integrity data). At 404, the server device can determine a metric indication of an interruption in the terrestrial network. The metric indication can indicate that the terrestrial network is experiencing an interruption when the metric value is below or above a particular threshold value (e.g., a predetermined threshold value indicating a terrestrial network interruption). For example, when network signal strength data received from the IoT devices indicates that the network signal strength is below a signal strength threshold value, and/or that the signal strength varies more than a signal strength stability threshold value, the server device determines that the terrestrial network is experiencing an interruption.

In some implementations, determining that the terrestrial network is experiencing the interruption includes using a machine learning (ML) predictive model trained using historical network infrastructure integrity data to predict whether an interruption is likely to occur. For example, an ML model can be trained using historical signal strength data associated with an outcome (e.g., that the network did or did not experience an interruption). The ML model can provide a likelihood for the terrestrial (or satellite) network to experience an interruption using the network signal strength data received from the IoT devices.

A “model,” as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language using an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the model for predicting network interruptions can be a neural network with multiple input nodes that receive network signal strength data. The input nodes can correspond to functions that receive the input and produce results. These results can be provided to one or more levels of intermediate nodes that each produce further results using a combination of lower-level node results. A weighting factor can be applied to the output of each node before the result is passed to the next layer node. At a final layer (“the output layer”), one or more nodes can produce a value classifying the input that, once the model is trained, can be used as an indication of a likelihood of network interruption. In some implementations, such neural networks, known as deep neural networks, can have multiple layers of intermediate nodes with different configurations, and can be a combination of models that receive different parts of the input and/or input from other parts of the deep neural network, or are convolutions—partially using output from previous iterations of applying the model as further input to produce results for the current input.

An ML model can be trained with supervised learning, where the training data includes historical network signal strength data as input and a desired output, such as a low likelihood of network interruption. A representation of the historical data can be provided to the model. Output from the model can be compared to the desired output and, using the comparison, the model can be modified, such as by changing weights between nodes of the neural network or parameters of the functions used at each node in the neural network (e.g., applying a loss function). After modifying the model in this manner, the model can be trained to evaluate new predictions of network interruptions.

At 406, the server device can identify a group of IoT devices to be switched from the terrestrial network to the satellite network using the monitoring data and the metric indication of an interruption in the terrestrial network. The group of IoT devices can include at least a portion of the IoT devices in communication with the server device. The group of IoT devices can be identified using a combination of the environmental data and the network infrastructure integrity data that allows the server device to evaluate which of the IoT devices are in the highest need of reliable network communication and therefore should be switched over to the satellite network. For example, as described above, the network infrastructure data can include signal strength and/or network congestion data and the environmental data can include data related to emergency conditions.

In some implementations, the server device determines a level of critical environmental conditions for each of the IoT devices. The critical environmental conditions provide indications of an environmental disaster using the environmental data. The server device can identify the group of IoT devices further using the determined level of critical environmental conditions for each of the IoT devices. For example, a first group of IoT devices can be located close to a hurricane path and are experiencing a high level of critical environmental conditions while a second group of IoT devices can be located further away from the hurricane path and are experiencing a lower level of critical environmental conditions. While both groups of the IoT devices are experiencing low terrestrial network reliability, the server devices would identify that the first group of IoT devices should be switched to the satellite network while the second group can continue communication through the terrestrial network. As another example, the first group of IoT devices can be located close to a city center while the second group of IoT devices is located in a remote, low-population location using GPS information. In other words, an environmental disaster can have more impact on humans in the city center. The server device would again identify that the first group of IoT devices should be switched to the satellite network while the second group can continue communication through the terrestrial network.

In some implementations, identifying the group of IoT devices is performed using geographical data associated with the IoT devices (e.g., GPS data). For example, a drone can change its position from a well-serviced urban area to a poorly serviced remote area. The geographical position in the remote area is an indication that the drone will likely have poor network connectivity through the terrestrial network. The server device can therefore identify that the IoT device positioned at the remote location should connect to the satellite network in order to maintain reliable communication.

At 408, the server device can cause the group of IoT devices to switch communication from the terrestrial network to the satellite network. For example, in FIG. 3, the IoT service enabler 312 can provide instructions to the OTA DP system 310 to cause the group of IoT devices (e.g., some or all of the IoT devices 302) to switch communication from the HPLMN 308 to the satellite network 314 of the VPLMN 304. The OTA DP system 310 will cause the switch to happen, e.g., via a device update performed using LwM2M protocol. For example, the LwM2M protocol is implemented by defining an appropriate object that represents a collection of resources for functionality or feature of an IoT device. The object can specify an object ID, resource IDs, data types, operations (read, write, execute) and whether the operations are mandatory or optional. The resources can list, for example, all available network bearers and a preferred network bearer. In order to enable the operation of the object, the object is implemented on the IoT devices by integrating the object into the device’s firmware.

The LwM2M protocol can enable a structured way to manage IoT devices and their connectivity. To implement a feature for switching between the satellite and terrestrial networks, the system can leverage LwM2M resources that pertain to connectivity management. Exemplary LwM2M resources include a connectivity monitoring (e.g., using the signal strength to determine if the satellite or terrestrial network has a stronger signal, and deciding which one to use based on this data); Access Point Name (APN) connection profile object (e.g., create separate APN profiles for terrestrial and satellite networks and switching between these profiles based on the connectivity criteria like cost or bandwidth); communication network bearer selection (e.g., managing network preference settings directly through network bearer object and enabling the IoT device to automatically switch to the preferred bearer when conditions are met); and network bearer selection (e.g., upon a command or when predefined conditions are met (like deteriorating signal strength or increased data costs), the executing a network switch by the IoT device using this resource).

In some implementations, subsequent to causing the group of IoT devices to switch the communication to the satellite network, the server device continues receiving the monitoring data from the IoT devices. The server device can perform load balancing using the monitoring data to determine whether the group of IoT devices should connect to the terrestrial network or the satellite network to maintain (or enhance) the performance of the terrestrial network and the satellite network (e.g., so that neither of the networks experiences congestion). In response to a determination that the group of IoT devices should connect to the terrestrial network, the server device can cause the group of IoT devices to switch communication from the satellite network back to the terrestrial network. Generally, the terrestrial network is a default (preferred) network for the IoT device due to, for example, cost reasons. The server device therefore performs continuous monitoring and evaluation of the network to be used.

In some implementations, the sensors of the IoT devices include a network signal strength sensor configured to capture the signal strength of the terrestrial network and/or the satellite network. The server device is caused to determine which signal strength of the signal strength of the terrestrial network and the satellite network is stronger using the captured signal strength of the terrestrial network and the satellite network. Defining the group of IoT devices to be switched from the terrestrial network to the satellite network can be further performed partly using the determination of the stronger signal strength. For example, an IoT device can be positioned in a location that does not have a strong satellite network signal strength. In such instances, the IoT device should continue communication via the terrestrial network.

In some implementations, subsequent to causing the group of IoT devices to switch the communication to the satellite network, the server device can receive an indication from a particular IoT device of the group of IoT devices that the particular IoT device no longer requires communication via the satellite network. The server device can cause the particular IoT device to switch communication from the satellite network to the terrestrial network. For example, the indication can include environmental data that indicates that the IoT device is no longer positioned at a location that has a high level of critical environmental conditions and therefore the IoT device can continue communication through the terrestrial network. As another example, the indication can include terrestrial network signal strength data that indicates that the IoT device is experiencing a terrestrial signal strength that is above a particular threshold (e.g., the terrestrial network is operating without congestion or interruptions) and therefore the IoT device can continue communication through the terrestrial network.

In some embodiments, the group of IoT devices can automatically switch back to using the terrestrial network when the terrestrial network is no longer experiencing an interruption. For example, an IoT device can automatically switch back to the terrestrial network when the network signal strength data collected by the sensor of the IoT device indicates that the signal strength is above the signal strength threshold. In some implementations, the group of IoT devices can be configured to switch back to the terrestrial network automatically after a pre-determined period of time (e.g., after 30 mins, an hour, 5 hours, or 10 hours). In some implementations, the group of IoT devices can be configured to switch back to the terrestrial network automatically if their geographical location has changed to a pre-determined geographical area (or away from a pre-determined geographical area). For example, an IoT device can automatically switch back to the terrestrial network when the IoT device has changed its location from a remote area to an urban area, or has changed its location from a high emergency area to a low emergency area. The location of the IoT device can be determined by, e.g., a GPS sensor of the IoT device.

In some implementations, the server device assesses the cost of data transmission in the terrestrial network and the satellite network and/or the bandwidth availability in the terrestrial network and the satellite network using additional monitoring data received from the IoT devices and/or other monitoring devices of the hybrid satellite and terrestrial telecommunications network system. The group of IoT devices can further be identified using the assessed cost of data and/or bandwidth availability. For example, the server device can include software that evaluates the cost of data and/or bandwidth availability and assesses the cost and/or bandwidth availability accordingly. In some implementations, the network switching is performed in an automatic manner but can be overridden manually by an operator of the server device. For example, the server device can be associated with a user interface operated on a computer device that allows an operator to review the monitoring data and other data associated (including receiving alerts and notifications) with the IoT devices and manually operate the network switching.

The disclosed hybrid terrestrial-satellite network for IoT devices enhances connectivity, efficiency, and security by dynamically switching between the networks using real-time conditions. Such ability can be crucial in environmental disasters and emergencies. The disclosed technology can optimize costs by prioritizing terrestrial networks and distributing data load to prevent congestion. The disclosed technology further considers analytics of signal strength, cost, and bandwidth availability to manage the hybrid network connectivity. In particular, the disclosed technology can ensure that IoT devices such as drones, and ground sensors can maintain connectivity to transmit critical data. The system can further be designed to operate to energy-efficiently to optimize battery life while maintaining reliable data transfer from the IoT devices.

The process 400 described with respect to FIG. 4 includes a terrestrial network as a default network (e.g., a first network) and satellite network as the network (e.g., a second network) that an IoT device can switch to in case the terrestrial network is experiencing an interruption. In some implementations, however, the same process can be applied in instances where the satellite network is the default network (e.g., the satellite network is the first network) and the terrestrial network is the network to which the device can switch to (e.g., the terrestrial is the second network).

### Computer System

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, video display device 518, an input/output device 520, a control device 522 (e.g., keyboard and pointing device), a drive unit 524 that includes a storage medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementation, the computer system 500 can be an embedded computer system, a system-on-chip (SOC), a single-board computer system (SBC) or a distributed system such as a mesh of computer systems or include one or more cloud components in one or more networks. Where appropriate, one or more computer systems 500 can perform operations in real-time, near real-time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

We claim:

1. A server device for managing a hybrid satellite and terrestrial telecommunications network system for Internet of Things (IoT) devices, the server device comprising:
at least one hardware processor; and
at least one non-transitory memory storing instructions, which, when executed by the at least one hardware processor, cause the server device to:
receive monitoring data from IoT devices in an IoT network while the IoT devices are communicating with the server device via a terrestrial network,
wherein each of the IoT devices includes a dual network interface controller (NIC) configured to facilitate connection of the respective IoT device to the terrestrial network and a satellite network,
wherein the IoT devices include sensors for capturing the monitoring data that includes network infrastructure integrity data and environmental data, and
wherein the environmental data describes environmental conditions surrounding a respective IoT device of the IoT devices;
determine, using the infrastructure integrity data in the monitoring data, a metric indication of an interruption in the terrestrial network;
identify, using the metric indication of the terrestrial network experiencing an interruption and the received environmental data, a group of IoT devices to be switched from the terrestrial network to the satellite network,
wherein the group of IoT devices includes at least a portion of the IoT devices in communication with the server device; and
cause the group of IoT devices to switch communication from the terrestrial network to the satellite network.

2. The server device of claim 1, further caused to:
subsequent to causing the group of IoT devices to switch the communication to the satellite network:
continue receiving the monitoring data from the IoT devices;
perform, using the monitoring data, load balancing to determine whether the group of IoT devices should connect to the terrestrial network or the satellite network to maintain performance of the terrestrial network and the satellite network; and
responsive to a determination that the group of IoT devices should connect to the terrestrial network, cause the group of IoT devices to switch communication from the satellite network to the terrestrial network.

3. The server device of claim 1, further caused to:
subsequent to causing the group of IoT devices to switch the communication to the satellite network:
receive an indication from a particular IoT device of the group of IoT devices that the particular IoT device no longer requires communication via the satellite network; and
cause the particular IoT device to switch communication from the satellite network to the terrestrial network.

4. The server device of claim 1,
wherein the sensors of the IoT devices include a network signal strength sensor,
wherein the network infrastructure integrity data includes network signal strength data, and
wherein the metric indication is determined using the network signal strength data.

5. The server device of claim 1, further caused to:
assess a cost of data transmission in the terrestrial network and the satellite network and/or a bandwidth availability in the terrestrial network and the satellite network using additional monitoring data received from the IoT devices and/or other monitoring devices of the hybrid satellite and terrestrial telecommunications network system; and
define the group of IoT devices further using assessed cost of data and/or bandwidth availability.

6. The server device of claim 1,
wherein the sensors of the IoT devices include one or more sensors for detecting environmental conditions associated with an environmental disaster.

7. The server device of claim 1, further caused to:
determine, using the environmental data, a level of critical environmental conditions for each of the IoT devices, the critical environmental conditions being indications of an environmental disaster,
wherein defining the group of IoT devices is further using the determined level of critical environmental conditions for each of the IoT devices.

8. The server device of claim 1,
wherein the NIC is configured to maintain connections to the terrestrial network and the satellite network simultaneously.

9. The server device of claim 1,
wherein an internet protocol (IP) address associated with a particular IoT device of the IoT devices remains unchanged when the IoT device is caused to switch communication from the terrestrial network to the satellite network.

10. The server device of claim 1,
wherein the IoT devices include drones and/or ground sensors deployed across a geographical region having a high risk of environmental disasters.

11. The server device of claim 1,
wherein determining that the terrestrial network is experiencing the interruption includes using a machine learning predictive model trained using historical network infrastructure integrity data to predict whether an interruption is likely to occur.

12. The server device of claim 1,
wherein the sensors of the IoT devices include a network signal strength sensor configured to capture signal strength of the terrestrial network and the satellite network,
wherein the server device is caused to determine, using the captured signal strength of the terrestrial network and the satellite network, which signal strength of the signal strength of the terrestrial network and the satellite network is stronger, and
wherein defining the group of IoT devices to be switched from the terrestrial network to the satellite network is performed partly using the determination of the stronger signal strength.

13. The server device of claim 1,
wherein the server device is configured to manage connectivity of the IoT device using a lightweight machine-to-machine (LwM2M) protocol using over-the-air device provisioning (OTA DP).

14. A server device for managing a hybrid network system for Internet of Things (IoT) devices, the system comprising:
at least one hardware processor; and
at least one non-transitory memory storing instructions, which, when executed by the at least one hardware processor, cause the server device to:
receive monitoring data from IoT devices in an IoT network while the IoT devices are communicating with the server device via a first network,
wherein each of the IoT devices includes equipment to facilitate connection of the respective IoT device to the first network and a second network, and
wherein the monitoring data includes network infrastructure integrity data and environmental data;
determine, using the network infrastructure integrity data, that the first network is experiencing an interruption;
identify, using the monitoring data, a group of IoT devices to be switched from the first network to the second network; and
cause the group of IoT devices to switch communication from the first network to the second network.

15. The server device of claim 14, further caused to:
subsequent to causing the group of IoT devices to switch the communication to the second network,
continue receiving the monitoring data from the IoT devices;
perform, using the monitoring data, load balancing to determine whether the group of IoT devices should connect to the first network or the second network to maintain performance of the first network and the second network; and
responsive to a determination that the group of IoT devices should connect to the first network, cause the group of IoT devices to switch communication from the second network to the first network.

16. The server device of claim 14, further caused to:
subsequent to causing the group of IoT devices to switch the communication to the second network,
receive an indication from a particular IoT device of the group of IoT devices that the particular IoT device no longer requires communication via the second network; and
cause the particular IoT device to switch communication from the second network to the first network.

17. The server device of claim 14,
wherein each of the IoT devices includes a network signal strength sensor, and
wherein the network infrastructure integrity data includes network signal strength data.

18. The server device of claim 14,
wherein the first network and the second network are selected from a terrestrial network and a satellite network, and the first network is different from the second network.

19. A method for managing a hybrid network system for Internet of Things (IoT) devices, comprising:
receiving, by a server device, monitoring data from IoT devices in an IoT network while the IoT devices are communicating with the server device via a first network,
wherein each of the IoT devices includes equipment to facilitate connection of the respective IoT device to the first network and a second network, and
wherein the monitoring data includes network infrastructure integrity data and environmental data;
determining, by the server device, using the network infrastructure integrity data, that the first network is experiencing an interruption;
defining, by the server device, using the monitoring data, a group of IoT devices to be switched from the first network to the second network; and
causing, by the server device, the group of IoT devices to switch communication from the first network to the second network.

20. The method of claim 19, further caused to:
subsequent to causing the group of IoT devices to switch the communication to the second network,
continuing to receive the monitoring data from the IoT devices;
performing, using the monitoring data, load balancing to determine whether the group of IoT devices should connect to the first network or the second network to maintain performance of the first network and the second network; and
responsive to a determination that the group of IoT devices should connect to the first network, causing the group of IoT devices to switch communication from the second network to the first network.
